(19) United States
(12) Patent Application Publication
(10) Pub. No.: US 2008/0319964 A1
(43) Pub. Date: Dec. 25, 2008

(54) SYSTEMS, ARTICLES AND METHODS OF PREFERENCE FILTERING FOR DATABASE QUERIES

(76) Inventors: Michael Coury, Vancouver (CA); William Macready, Vancouver (CA); Kai Fan Tang, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/143,639

(22) Filed: Jun. 20, 2008

Related U.S. Application Data
(60) Provisional application No. 60/945,863, filed on Jun. 22, 2007.

(51) Int. Cl. G06F 7/06; G06F 17/30

(52) U.S. Cl. 707/4; 707/E17.017

(57) ABSTRACT

Systems, methods and articles for performing preference filtering on a database query. Example embodiments provide a new algorithm, called BNL#, that operates with a worst-case running time of O(nₜcₑ+nₑ+nₚ) where {nₑ, nₚ}<<nₜ→O(nₜcₑ). This represents an improvement over existing algorithms that are known in the art, such as the BNL algorithm which operates with a worst-case running time of O(nₜ²) and the BNL++ algorithm which operates with a worst-case running time of O(nₜcₑnₑmₑ), with nₑ<<nₜ. This abstract is provided to comply with rules requiring an abstract, and is submitted with the intention that it will not be used to interpret or limit the scope or meaning of the claims.

### CROSS REFERENCE TO RELATED APPLICATIONS

This application claims benefit under 35 U.S.C. 119(e) of U.S. Provisional Patent Application Ser. No. 60/945,863, filed Jun. 22, 2007 and entitled “Apparatus, Article and Method of Preference Filtering for Database Queries,” which is incorporated herein by reference in its entirety.

### FIELD

The present systems, articles and methods generally relate to improving the efficiency of preference filtering schemes for database queries.

### BACKGROUND

### Databases and Query Languages

Many entities employ relational databases to store information. The information may be related to almost any aspect of business, government or personal life. For example, the information may be related to human resources, transportation, order placement or picking, warehousing, distribution, budgeting, oil exploration, surveying, polling, images, geographic maps, network topologies, identification, security, commercial transactions, etc.

A relational database stores a set of “relations” or “relationships.” A relation is a table with at least two-dimensions. The columns of the table are called attributes and the rows of the table store instances or “tuples” of the relation. A tuple may have one element for each attribute of the relation. The schema of the relation may include the name of the relation and the names and data types of all attributes. Typically, many such relations are stored in the database with any given relation having perhaps millions of tuples.

Searching databases typically employs the preparation of one or more queries expressed in a declarative language, such as a data query language. One common way of formatting queries is through Structured Query Language (SQL). SQL-99 is the most recent standard, however many database vendors offer slightly different dialects or extensions of this standard. The basic query mechanism in SQL is the statement: SELECT L FROM R WHERE C, in which L identifies a list of columns in the relation(s) R, and c is a condition that evaluates to TRUE, FALSE or UNKNOWN. Typically, only tuples that evaluate to TRUE are returned. Other query languages are also known, for example DATALOG, which may be particularly useful for recursive queries.

Traditional querying or searching of databases presents a number of problems. For example, boolean matching is particularly onerous and unforgiving; hence, searchers must specify a query that will locate the desired piece of information without locating too much undesired information. Overly constrained queries will have no exact answer, while queries with insufficient constraints will have too many answers to be useful. Thus, the searcher must correctly constrain the query with a suitable number of correctly selected constraints.

These problems limit the usefulness of existing data query languages and databases in particular, as well as various other programming or software development methodologies and technologies.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a flow-diagram that illustrates an embodiment of a method for evaluating preferences in database queries.

FIG. 2 is a functional diagram of an embodiment of an illustrative Better-Than Graph of equivalence classes.

FIG. 3 is a functional diagram of an embodiment of an illustrative Better-Than Graph of equivalence classes for which the database tuples have been allocated to their respective equivalence classes and the skyline has been determined.

FIG. 4 is a functional block diagram of a networked computing system suitable for operating the methods for evaluating preferences in database queries, according to at least one illustrated embodiment.

### SUMMARY

At least one embodiment may be summarized as a computer-implemented method of performing preference filtering for a database query including defining a number of conditions of a query; determining an equivalence class for each of a number of tuples in a set of database tuples for which at least one preference is to be evaluated; constructing a Better-Than Graph for the equivalence classes; determining a Best Matches Only set of equivalence classes from the Better-Than Graph of the equivalence classes; and returning the tuples resulting from the determining the Best Matches Only set of equivalence classes as the result of the preference filtering for the query. Defining a number of conditions of a query may include receiving a set of user input indicative of at least one condition that a query result must exactly meet. Defining a number of conditions of a query may include receiving a set of user input indicative of at least one condition that a query may or may not exactly meet.

The method may further include determining a subset of database tuples that a query result must exactly meet before determining an equivalence class for each of a number of tuples in a set of database tuples, and wherein determining the equivalence class for each of the number of tuples in the set of database tuples includes determining a respective equivalence class only for the database tuples in the determined subset of database tuples. Constructing a Better-Than Graph for the equivalence classes may include representing each equivalence class by a respective node in the Better-Than Graph, where a relative position of each node with respect to a connected node in a given direction represents a relative ranking of each equivalent class. Determining a Best Matches Only set of equivalence classes from the Better-Than Graph of equivalence classes may include determining a skyline of the Better-Than Graph and thereby producing a set of skyline equivalence classes. Returning any tuples resulting from the determining the Best Matches Only set of equivalence classes may include returning any tuples that are contained in the set of skyline equivalence classes. Determining a skyline of the Better-Than Graph may include performing a depth-first search or a breadth-first search.

At least one embodiment may be summarized as a computer-implemented method of performing preference filtering for a database query including defining a number of conditions of a query, wherein at least one of the conditions is a requirement that must be exactly met by a query result and at least one of the conditions is a preference that may or may not be met by a query result; defining a general query that ignores the preferences and uses only the requirements; executing the general query to establish a subset of database tuples for which the preferences are to be evaluated; determining an equivalence class for each tuple in the subset of database tuples for which the preferences are to be evaluated; constructing a Better-Than Graph for the equivalence classes; determining a Best Matches Only set of equivalence classes from the Better-Than Graph of equivalence classes; and returning any tuples resulting from the determining the Best Matches Only set of equivalence classes as the result of the preference filtering for the query. Constructing a Better-Than Graph for the equivalence classes may include representing each equivalence class by a respective node in the Better-Than Graph, where a relative position of each node with respect to a connected node in a given direction represents a relative ranking of each equivalent class. Determining a Best Matches Only set of equivalence classes from the Better-Than Graph of equivalence classes may include determining a skyline of the Better-Than Graph and thereby producing a set of skyline equivalence classes. Returning any tuples resulting from the determining the Best Matches Only set of equivalence classes may include returning any tuples that are contained in the set of skyline equivalence classes. Determining a skyline of the Better-Than Graph may include performing a depth-first search or a breadth-first search.

At least one embodiment may be summarized as a system to perform preference filtering for database queries including a processor; and a memory storing processor executable instructions that cause the processor to perform preference filtering for a database query by: defining a number of conditions of a query; determining an equivalence class for each of a number of tuples in a set of database tuples for which at least one preference is to be evaluated; constructing a Better-Than Graph for the equivalence classes; determining a Best Matches Only set of equivalence classes from the Better-Than Graph of the equivalence classes; and returning the tuples that result from the determining a Best Matches Only set of equivalent classes. The processor may determine a Best Matches Only set of equivalence classes from the Better-Than Graph of the equivalence classes by determining a skyline of the Better-Than Graph and thereby producing a set of skyline equivalence classes. Returning the tuples that result from the determining a Best Matches Only set of equivalent classes may include returning the tuples that are contained in the set of skyline equivalence classes as the result of the preference filtering for the query.

At least one embodiment may be summarized as a system of performing preference filtering for database queries including a processor; and a memory storing processor executable instructions that cause the processor to perform preference filtering for a database query by: defining a number of conditions of a query, wherein at least one of the conditions is a requirement that must be exactly met by a query result and at least one of the conditions is a preference that may or may not be met by the query result; defining a general query that ignores the preferences and uses only the requirements; executing the general query to establish a subset of database tuples for which the preferences are to be evaluated; determining an equivalence class for each tuple in the subset of database tuples for which the preferences are to be evaluated; constructing a Better-Than Graph for the equivalence classes; determining a Best Matches Only set of equivalence classes from the Better-Than Graph of equivalence classes; and returning any tuples that result from the determining the Best Matches Only set of equivalence classes as the result of the preference filtering for the query. The memory may store processor executable instructions that cause the processor to determine a Best Matches Only set of equivalence classes from the Better-Than Graph of the equivalence classes by determining a skyline of the Better-Than Graph and thereby producing a set of skyline equivalence classes. The memory may store processor executable instructions that cause the processor to returning the tuples that result from the determining a Best Matches Only set of equivalent classes by returning the tuples that are contained in the set of skyline equivalence classes as the result of the preference filtering for the query.

At least one embodiment may be summarized as a system to perform preference filtering for database queries including means for defining a number of conditions of a query, determining an equivalence class for each of a number of tuples in a set of database tuples for which at least one preference is to be evaluated, constructing a Better-Than Graph for the equivalence classes, determining a Best Matches Only set of equivalence classes from the Better-Than Graph of the equivalence classes by determining a skyline of the Better-Than Graph and thereby producing a set of skyline equivalence classes, and returning the tuples that are contained in the set of skyline equivalence classes as the result of the preference filtering for the query. The means may comprise instructions stored on a computer readable medium.

At least one embodiment may be summarized as a system of performing preference filtering for database queries including means for defining a number of conditions of a query, wherein at least one of the conditions is a requirement that must be exactly met by a query result and at least one of the conditions is a preference that may or may not be met by the query result, defining a general query that ignores the preferences and uses only the requirements; executing the general query to establish a subset of database tuples for which the preferences are to be evaluated, determining an equivalence class for each tuple in the subset of database tuples for which the preferences are to be evaluated, constructing a Better-Than Graph for the equivalence classes, determining a Best Matches Only set of equivalence classes from the Better-Than Graph of equivalence classes by determining a skyline of the Better-Than Graph and thereby producing a set of skyline equivalence classes, and returning any tuples that are contained in the set of skyline equivalence classes as the result of the preference filtering for the query. The means may comprise instructions stored on a computer readable medium.

### DETAILED DESCRIPTION

In the following description, certain specific details are set forth in order to provide a thorough understanding of various embodiments of the present systems, articles and methods. However, one skilled in the art will understand that the present systems, articles and methods may be practiced without these details. In other instances, well-known structures associated with computers have not been shown or described in detail to avoid unnecessarily obscuring descriptions of the embodiments of the present systems, articles and methods.

Unless the context requires otherwise, throughout the specification and claims which follow, the words “comprise” and “include” and variations thereof, such as, “comprises”, “comprising”, “includes” and “including” are to be construed in an open, inclusive sense, that is, as “including, but not limited to.” Reference throughout this specification to “one embodiment”, “an embodiment”, “one alternative”, “an alternative” or similar phrases means that a particular feature, structure or characteristic described is included in at least one embodiment of the present systems, articles and methods. Thus, the appearances of such phrases in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the claimed invention.

Unless the context requires otherwise, throughout the specification and claims which follow, references to a computer language, such as SQL, encompass various implementations of that language, regardless of whether the language standard is partially implemented or modifications have been introduced in a particular implementation. Thus, for example, when SQL is used, reference is intended to include real-world SQL implementations as used by various database servers (e.g., Oracle, MySQL, PostgreSQL, Microsoft SQL Server), regardless of an implementation's adherence to any of the SQL standards. For ease of understanding, SQL will be used as an illustrative declarative data query language and a relational database will be used as an exemplary data source but such should not be considered limiting. Those of skill in the art will appreciate that while data query languages such as SQL are occasionally referred to herein, reference to a particular data query language is for illustrative purposes only, and the present systems, articles and methods may be employed using any declarative language, data query language, and/or declarative language features provided in the context of other types of languages, such as object oriented languages, scripting languages, logic programming languages, etc.

The present systems, articles and methods describe techniques of performing preference filtering on database queries. The techniques described herein improve upon existing state-of-the art methods because the present systems, articles and methods may produce the same results more quickly than existing state-of-the-art methods and/or a more accurate result in the same amount of time as existing state-of-the-art methods.

Databases are a part of many aspects of human life today and they are often used or operated upon by queries. These queries may impose constraints that traditional database management systems (DBMSs) attempt to satisfy in their entirety. Often, this can lead to queries that either return no results due to being over-constrained or return too many results due to being under-constrained. For instance, in a standard SQL query all conditions of the query must be met in order to return a result. Thus, it can be difficult to obtain a best result to a standard SQL query when all of the results returned are equally good in that they satisfy the query conditions. Attempts to refine the query conditions often result in either over-constrained queries which give no results or under-constrained queries which give too many results. Therefore, there is a need for a technology that will allow a user to specify a constrained query that allows for the return of the best answer available, especially if there is no exact answer to their query. There are a few approaches to solving this problem in the art, as described for example in: S. Borzsonyi et al., “The skyline operator”, in IEEE Conference on Data Engineering, Heidelberg, Germany, pp. 421-430, 2001, and in W. Kiessling, “Foundations of preferences in database systems”, in Proceedings of the 28^{th} VLDB Conference, 2002, as well as in J. Chomicki, “Querying with intrinsic preferences”, in International Conference on Extending Database Technology, pp. 34-51, 2002. Many existing approaches make use of the concept of preferences. Preferences allow a user to say that they prefer one thing to another, which is equivalent to creating a strict partial order over a domain. Then, the DBMS may return the best matching tuples as a result set.

### Preferences

Understanding preferences is natural and intuitive, but defining them for the purpose of a database query is not necessarily either. One may be required to precisely construct their preferences and accumulate these constructions. Therefore, one may define a number of constructors, basic and complex, numerical and non-numerical. For example, these constructors may take the form of specifying either positive or negative preferences (e.g., likes or dislikes), or specifying numerical properties or relationships such as equal, between, lowest and highest in the case of numerical preferences.

The answer semantics of database queries involving preferences follow the “Best Matches Only” model (from W. Kiessling et al., “Preference sql-design, implementation, experiences”, in Proceedings of the 28th VLDB Conference, 2002). Given a query with preferences, its answer is the maximal set of best matching tuples with respect to the preferences. A tuple t is a best match in the sense that no other tuple can be considered better than t with respect to the preferences. The set of best matches is called the Best Matches Only (BMO) set. Because it may not be necessary to require that preferences be specified as a total ordering over the tuples, it is possible to obtain a BMO set that contains incomparable tuples. In fact, preferences often impose only a partial ordering over the domain of candidate choices. This is where the need for complex preference constructors fits in.

If we consider two preferences, neither of which has an ordering with respect to the other, then we can define a Pareto preference to say that the preferences are equally important. For example, if a user is looking for a computer with a CPU speed of at least 3 GHz and a main memory capacity of at least 4 GB, the user can specify that the CPU speed and the main memory capacity are equally important. The BMO set of a Pareto preference is also called the Pareto Optimal set.

Similarly, it can be convenient to define preferences where one is considered more important than the other. For example, if a user is looking to book a plane ticket with the cheapest fare but he/she prefers one airline to another, the user can specify that the fare price is more important than the airline. These forms of preferences can be defined as a sequence of preferences, called a prioritization.

Finally, any of these constructions may be combined in order to create a definition of a complicated preference similar to one that would occur naturally. The following example is used in W. Kiessling et al., “Preference sql-design, implementation, experiences”, in Proceedings of the 28^{th} VLDB Conference, 2002:

“My favorite car must be an Opel. It should be a roadster, but if there is none, please no passenger car. Equally important I want to spend around $40,000 and the car should be as powerful as possible. Less important I like a red one. If there remain several choices, let better mileage decide.”

Preference SQL describes a method for incorporating partial orders into standard SQL queries. This is done through the introduction of new keywords and grammars into the standard SQL lexicon. However, in some cases this may not be sufficient. It may also be necessary to include support for the extended syntax. For some applications, the preferred method may be direct integration to a DBMS, but it is also possible to implement Preference SQL as an adjunct as described in W. Kiessling et al., “Preference sql-design, implementation, experiences”, in Proceedings of the 28^{th} VLDB Conference, 2002. In this latter case, the partial orders may be rewritten through a set of predefined rules into standard SQL and this new query may be executed by the DBMS.

Preference SQL adds new syntax to SQL for describing preferences. The typical SELECT query is extended to allow for this:

| | |
|---|---|
| SELECT | <fields> |
| FROM | <tables> |
| WHERE | <where conditions> |
| PREFERRING | <soft conditions> |
| GROUP BY | <group-by fields> |
| ORDER BY | <order-by fields>. |

### EXAMPLES

### Base Preferences

Approximation

SELECT * FROM trips
PREFERRING duration = 14;

Minimization

SELECT * FROM apartments
PREFERRING area LOWEST;

Favorites

SELECT * FROM programmers
PREFERRING exp IN (‘java’, ‘C++’);

### EXAMPLES

### Complex Preferences

Pareto

SELECT * FROM computers
PREFERRING main_memory HIGHEST
AND cpu_speed HIGHEST;

Prioritization

SELECT * FROM computers
PREFERRING main_memory HIGHEST
PRIOR TO color IN (‘black’, ‘brown’);

### Algorithms

There are a number of known algorithms for evaluating preferences. At least two such algorithms are loosely based on block-nested loops (BNLs). These algorithms are known as “BNL” (or “naïve BNL”) and “BNL++”. The present systems, articles and methods describe an improvement upon these BNL-based algorithms, and accordingly this new technique is referred to herein as “BNL#” (read “BNL-sharp”).

The most basic algorithm (i.e., BNL) used by Preference SQL to evaluate preferences, is in principle a nested loop algorithm that compares every tuple to a candidate set of tuples. The BNL algorithm works as follows: for every tuple, compare it to every candidate in the candidate set and update the candidate set if necessary (for example, remove the candidate tuple if it is less preferred). Therefore, the running time of this algorithm is O(nₜsₜmₜu), where nₜ is the number of tuples, mₜ is the cost of comparing two tuples, u is the cost of updating the candidate set, and sₜ is the maximum size of the candidate set of tuples, which is O(nₜ). Thus, in the worst case the running time of the BNL algorithm is O(nₜ²).

An improved version of this algorithm is the BNL++ algorithm described in T. Preisinger et al., “The BNL++ algorithm for evaluating Pareto preference queries”, in Proceedings of the ECAI 2006 Multi-disciplinary Workshop on Advances in Preference Handling, 2006. This algorithm introduces the concept of equivalence classes for tuples, where an equivalence class is a set of tuples that are all equivalent with respect to the preferences defined. The algorithm works by, for every tuple, computing its equivalence class and determining whether the equivalence class is a candidate by comparing it to the equivalence classes in the candidate set. Therefore, the running time of this algorithm is O(nₜcₑsₑmₑu), where cₑ is the cost of computing the equivalence class for a tuple, mₑ is the cost of comparing two equivalence classes, u is the cost of updating the candidate set, and Se is the size of the candidate set of equivalence classes. The size of the candidate set is asymptotically similar to the number of equivalence classes, O(nₑ), so the worst case running time of the BNL++ algorithm is O(nₜcₑnₑmₑu), with nₑ<<nₜ.

The BNL# algorithm, as described in the present systems, articles and methods, represents an improvement on the BNL++ algorithm. It works by first computing the equivalence class for every tuple and then finding the BMO set from the Better-Than Graph, which is similar in both concept and size to the candidate set. A naive method for determining the BMO set from the Better-Than Graph G is to use a breadth-first search; similarly, this comparison could be conducted as a depth-first search. Both searches run in linear time with respect to the size of the adjacency-list representation of G, or the number of vertices and edges, O(V+E). There is, in fact, an algorithm for discovering the optimal non-empty set of equivalence classes in linear time, with respect to the number of equivalence classes. The number of vertices in the Better-Than Graph is at most the number of equivalence classes, nₑ, and the number of edges coming out of each vertex is at most the number of preferences, nₚ. Therefore, the worst case running time of the BNL# algorithm is O(nₜcₑ+nₑ+nₑnₚ), where nₑ<<nₜ and nₚ<<nₑ. The BNL# algorithm described in the present systems, articles and methods represents an improvement over existing algorithms because its running time is typically shorter.

### Better-Than Graph

A Better-Than Graph (BTG) is a Hasse diagram; that is, a graphical representation of a poset. This diagram is also a directed acyclic graph (DAG) and is constructed as follows: For each element of the poset, create a vertex. There is an edge between two vertices u and v if u<v in the poset and there is no w in the poset such that u<w and w<v. If u<v, then u appears lower in the diagram than v. We can generalize this by using the notion of equivalence classes and creating the BTG where each vertex is an equivalence class and the edges are defined by the relationships between the equivalence classes. For more details on Better-Than Graphs and Hasse diagrams, see S. Skiena, “Hasse Diagrams”, in Implementing Discrete Mathematics: Combinatorics and Graph Theory with Mathmetica, Adison-Wesley, 1990.

### BNL#

In brief summation, the BNL algorithm involves the following approach: tuples are compared with respect to the query criteria and the tuple that better satisfies the query criteria is categorized into a candidate set of tuples, where the candidate set represents tuples that may best satisfy the query criteria. Thus, every tuple in the database is individually compared against the candidate set. When a tuple is found to be equally as good as a tuple already in the candidate set, the new tuple is added to the candidate set. When a tuple is found to be better than a tuple in the candidate set, the new tuple replaces all or a portion of the tuples in the candidate set. After the final comparison, the candidate set is returned as the result of the database query. The disadvantage of the BNL algorithm is that it is slow to compute.

By comparison, the BNL++ algorithm involves establishing a set of “equivalence classes”, each of which represents a set of potential tuples that, should such tuples exist, satisfy some portions of the query conditions in different but equally preferred ways. Tuples within such a set are equally good within the scope of the conditions stipulated within the query, and therefore such a set may be referred to as a “set of equally good tuples”. The BNL++ algorithm computes the equivalence class for each tuple in a database and then compares equivalence classes to establish a candidate set of equivalence classes. As in BNL, the candidate set improves with successive iterations, and the final candidate set is returned as the result of the query. BNL++ represents an improvement over BNL in that BNL++ has a running time that is shorter than that of BNL.

The present systems, articles and methods describe a new algorithm for evaluating preferences in database queries. This algorithm is referred to herein as BNL# and it represents an improvement over existing algorithms, such as BNL and BNL++, that are known in the art. BNL# is an improvement over these algorithms because its running time is typically shorter. The BNL# algorithm involves grouping each tuple into a respective equivalence class. Once the tuples have been grouped into their respective equivalence classes, a BTG is constructed for the equivalence classes. This BTG represents a ranking among the equivalence classes. In the BTG, equivalence classes are represented as nodes, and the relationships between equivalence classes are represented by edges. An edge that connects two equivalence classes indicates that the lower of the two connected equivalence classes is dominated by (i.e., less preferred than) the higher of the two connected equivalence classes. Domination is transitive, and therefore a path (i.e., a sequence of one or more consecutive edges) that connects two equivalence classes indicates that the lower of the two connected equivalence classes is dominated by the higher of the two connected equivalence classes. The result of the query may be established by determining the BMO set of the BTG. The BMO set of the BTG may be represented by the “skyline” of the BTG, and finding the skyline of the BTG is fast because the BTG is a DAG (linear time with respect to the number of vertices and edges).

In some embodiments, it may be advantageous to first run a general query that includes only the required conditions that must be met to produce an acceptable result. In such embodiments, the remaining acts of the BNL# algorithm may be performed on the subset of tuples from the database that satisfy the required conditions of the general query.

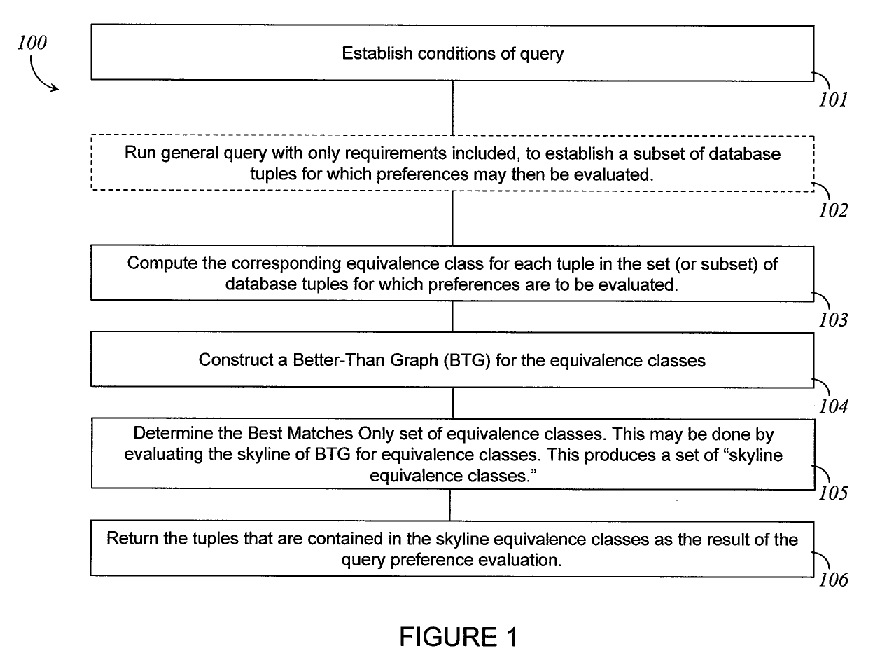

FIG. 1 is a flow-diagram that illustrates an embodiment of a method 100 for evaluating preferences in database queries. Method 100 represents an embodiment of the BNL# algorithm. In act 101, the query is defined. This may involve establishing a set of conditions which may be desired characteristics of the result tuple(s) from the database. In act 102, any conditions of the query that are requirements, that is, conditions that must be met by the result tuple(s) may be compiled into a general query. This general query may be run to establish a subset of database tuples for which the preferences (i.e., non-required conditions) may be evaluated. Act 102 is optional, and may only apply in certain embodiments of the BNL# algorithm. For instance, in such embodiments it may be advantageous to reduce the scope of the subsequent acts of the BNL# algorithm by limiting the evaluated tuples to only the set of tuples that have a chance of being satisfactory result tuples. Act 102 may limit the scope of the preference evaluation, but act 102 may also significantly reduce the running time of the algorithm.

In act 103, an equivalence class is computed for each of the tuples in the database for which preferences are to be evaluated. In embodiments where act 102 is omitted, then act 103 may involve computing the equivalence class of every tuple in the database. In embodiments where act 102 is included, then act 103 may involve computing the equivalence class of only those tuples which satisfy the requirements of the general query from act 102. In act 104, a Better-Than Graph (BTG) is constructed for the equivalence classes. In act 105, the BTG is analyzed to determine the BMO set of equivalence classes. The BMO set of equivalence classes may be determined by evaluating the “skyline” of the BTG, thereby producing a set of “skyline equivalence classes.” In some embodiments, the skyline may be evaluated using a method that is linear in the size (e.g., the number of edges and/or the number of nodes) of the BTG. For example, in some embodiments the skyline may be evaluated using a “breadth-first search” as opposed to a “depth-first search.” In act 106, the database tuples that are contained in the set of skyline equivalence classes may be returned as the result(s) of the query preference evaluation.

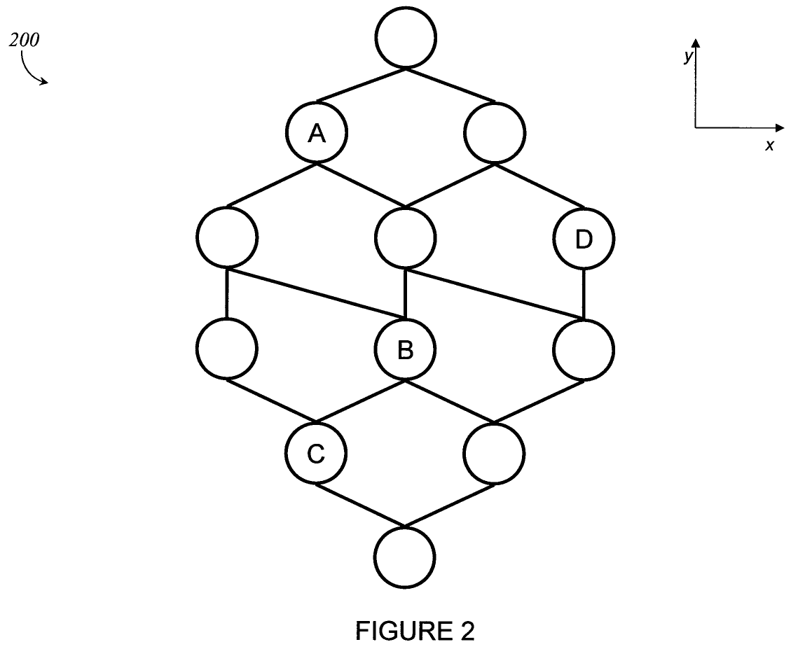

FIG. 2 is a functional diagram of an embodiment of an illustrative Better-Than Graph (BTG) 200 of equivalence classes. In FIG. 2, each equivalence class is represented by a vertex or node, illustrated as a circle in BTG 200. The relative positions of the vertices or nodes (circles) in the y-direction (as defined by the y-axis in FIG. 2) represent the relative ranking of each equivalence class. If two equivalence classes are connected by a path, the one that is higher in the y-direction is preferred over the one that is lower. For instance, in FIG. 2 equivalence class A is preferred over equivalence classes B and C, while equivalence class B is preferred over equivalence class C. However, there is no relationship indicated between equivalence classes A and D, and therefore no statement can be made about which of equivalence classes A and D is preferred.

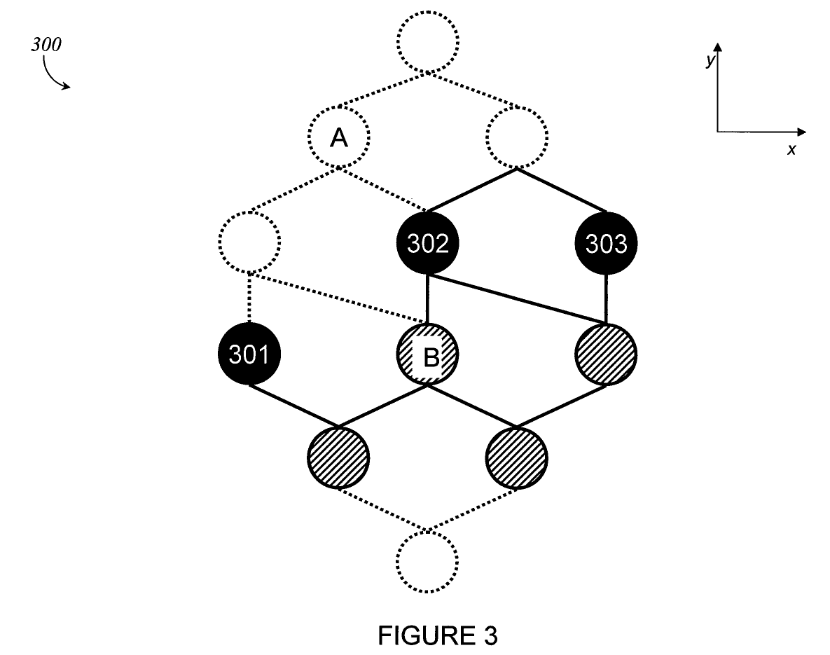

FIG. 3 is a functional diagram of an embodiment of an illustrative Better-Than Graph (BTG) 300 of equivalence classes for which the database tuples have been allocated to their respective equivalence classes and the skyline has been determined. In BTG 300, equivalence classes are represented by vertices or nodes, illustrated as circles, and relationships are represented by edges, illustrated by lines, as in BTG 200. However, in BTG 300, equivalence classes which do not contain any tuples are shown filled in white with a broken-line border and edges that connect to such equivalence classes are represented by broken lines. For instance, in BTG 300 equivalence class A does not contain any tuples. As part of the BNL# algorithm, the skyline of BTG 300 has been determined to produce a set of skyline equivalence classes. Equivalence classes that form the skyline of BTG 300 are shown filled-in solid black, and thus equivalence classes 301-303 form the set of skyline equivalence classes in BTG 300. Furthermore, equivalence classes that do contain tuples but are contained in at least one skyline equivalence class are shown filled with diagonal lines in BTG 300. For instance, in BTG 300 equivalence class B does contain tuples but it is dominated by skyline equivalence class 302. FIG. 3 helps to illustrate that the skyline of a BTG is the set of uncontained equivalence classes that have the highest ranking. In the BNL# algorithm, the tuples that are contained in equivalence classes 301-303 may be returned as the preferred results of the query for which preferences have been evaluated.

### System Hardware

The following discussion provides a brief, general description of a suitable computing environment in which the embodiments described herein may be implemented. Although not required, various embodiments will be described in the general context of computer-executable instructions, such as program application modules, objects, or macros being executed by a personal computer. Those skilled in the relevant art will appreciate that various embodiments can be practiced with other computing system configurations, including handheld devices, multiprocessor systems, microprocessor-based or programmable consumer electronics, networked personal computers (PCs), minicomputers, quantum computers, mainframe computers, and the like. Various embodiments can be practiced in distributed computing environments where tasks or modules are performed by remote processing devices, which are linked through a communications network. In a distributed computing environment, program modules may be located in both local and remote memory storage devices.

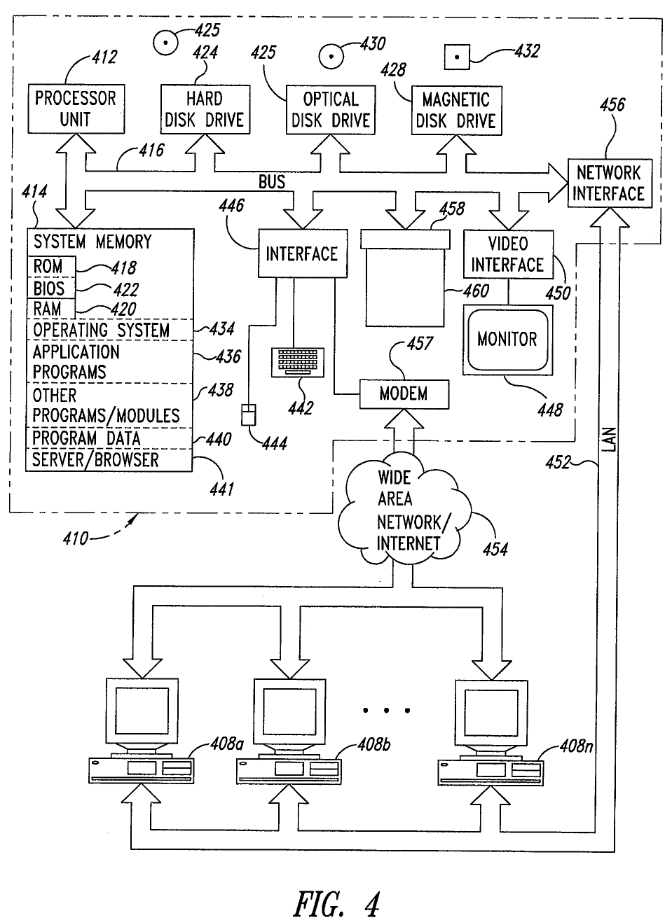

FIG. 4 shows a number of end user computing systems 408a-408n networked with a host computing system 410. The host computing system 410 may, for example, be operated by an application vendor, or an end user organization. The end user computing systems 408a-408n may, for example, be operated by one or more end users, such as employees of the end user organization. The end user computing systems 408a-408n may take the form of any of the variety of types discussed above, which may run a networking client, for example a Web browser. The host computing system 410 may take the form of any of the variety of types discussed above, which may run a networking client, for example a server. While the discussion immediately below is directed to the host computing system 410, many of the structures, functions and other aspects are relevant to the structure and operation of the end user computing systems 408a-408n, and thus will not be repeated in the interest of brevity and clarity.

The host computing system 410 includes a processor unit 412, a system memory 414 and one or more system buses 416 that couples various system components including the system memory 414 to the processor unit 412. The processor unit 412 may be any logical processor unit, such as one or more microcontrollers, central processor units (CPUs), microprocessors (e.g., CORE2 Extreme or DUO, PENTIUM or other processors available from INTEL; PowerPC or 68000 series processors available from MOTOROLA; OPTERON, ATHLON and other processors available from AMD), digital signal processors (DSPs) (e.g., MC56000 or TMS320 DSPs), application-specific integrated circuits (ASIC) (e.g., ASICs available from CHARTERED, CPACKETS, FIJITSU, IBM, INFINEON TECHNOLOGIES, MOSIS, NEC, SAMSUNG, OR TEXAS INSTRUMENTS), field programmable gate arrays (FPGAs) (e.g., VIRTEX, VIRTEX-II, VIRTEX-4, SPARTAN, XGC and other FPGAs available from XILINX; STRATIX and other FPGAs available from ALTERA; FPGAs available from LATTICE SEMICONDUCTOR, ACTEL, ATMEL, QUICKLOGIC, ACHRONIX SEMICONDUCTOR, MATH STAR) or hybrid devices (e.g., devices with processors embedded in FPGA's logic available from XILINX), etc. Unless described otherwise, the construction and operation of the various blocks shown in FIG. 4 are of conventional design. As a result, such blocks need not be described in further detail herein, as they will be understood by those skilled in the relevant art.

The system bus 416 can employ any known bus structures or architectures, including a memory bus with memory controller, a peripheral bus, and/or a local bus. The system bus 416 may, for example, include separate data, instruction and/or power buses. The system memory 414 may include read-only memory (“ROM”) 418 and random access memory (“RAM”) 420. A basic input/output system (“BIOS”) 422, which can form part of or be stored in the ROM 418, contains basic routines that help transfer information between elements within the host computing system 410, such as during startup.

The host computing system 410 also includes one or more spinning media memories such as a hard disk drive 424 for reading from and writing to a hard disk 425, and an optical disk drive 426 and a magnetic disk drive 428 for reading from and writing to removable optical disks 430 and magnetic disks 432, respectively. The optical disk 430 can be a CD-ROM, while the magnetic disk 432 can be a magnetic floppy disk or diskette. The hard disk drive 424, optical disk drive 426 and magnetic disk drive 428 communicate with the processor unit 412 via the bus 416. The hard disk drive 424, optical disk drive 426 and magnetic disk drive 428 may include interfaces or controllers coupled between such drives and the bus 416, as is known by those skilled in the relevant art, for example via an IDE (i.e., Integrated Drive Electronics) interface. The drives 424, 426 and 428, and their associated computer-readable media, provide nonvolatile storage of computer-readable instructions, data structures, program modules and other data for the host computing system 410. Although the depicted host computing system 410 employs hard disk 425, optical disk 430 and magnetic disk 432, those skilled in the relevant art will appreciate that other types of spinning media memory computer-readable media may be employed, such as, digital video disks (“DVD”), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 414, such as an operating system 434, one or more application programs 436, other programs or modules 438, and program data 40. The system memory 414 also includes a server 441 for permitting the host computing system 410 to exchange data with sources such as Websites of the Internet, corporate intranets, or other networks, as well as other server applications on server computers. The server 441 is markup language based, such as hypertext markup language (“HTML”), and operate with markup languages that use syntactically delimited characters added to the data of a document to represent the structure of the document. The server can perform one or more of a variety of functions, for example, taking the from of one or more of a file server, database server, backup server, print server, mail server, web server, FTP server, application server, VPN server, DHCP server, DNS server, WINS server, logon server, security server, domain controller, backup domain controller, proxy server, firewall, etc. Server 441 may, for example take the form of WINDOWS 2000 server available from MICROSOFT. The system memory 414 may also include a browser (e.g., INTERNET EXPLORER, or other browsers available from MICROSOFT, FIREFOX or other browsers available from MOZZILA, NAVIGATOR or other browsers available from NETSCAPE) or similar programs.

While shown in FIG. 4 as being stored in the system memory 414, the operating system 434, application programs 436, other program modules 438, program data 440 and server 441 can be stored on the hard disk 25 of the hard disk drive 424, the optical disk 430 and the optical disk drive 426 and/or the magnetic disk 432 of the magnetic disk drive 428. A user can enter commands and information to the host computing system 410 through input devices such as a keyboard 442 and a pointing device such as a mouse 444. Other input devices can include a microphone, joystick, game pad, scanner, etc. These and other input devices are connected to the processor unit 412 through an interface 446 such as a serial port interface that couples to the bus 416, although other interfaces such as a parallel port, a game port or a universal serial bus (“USB”) can be used. A monitor 448 or other display devices may be coupled to the bus 416 via video interface 450, such as a video adapter. The host computing system 410 can include other output devices such as speakers, printers, etc.

The host computing system 410 can operate in a networked environment using logical connections to one or more end user computing systems 408a-408n. The host computing system 410 may employ any known means of communications, such as through a local area network (“LAN”) 452 or a wide area network (“WAN”) or the Internet 454. Such networking environments are well known in enterprise-wide computer networks, intranets, and the Internet.

When used in a LAN networking environment, the host computing system 410 is connected to the LAN 452 through an adapter or network interface 456 (communicatively linked to the bus 416). When used in a WAN networking environment, the host computing system 410 often includes a modem 457 or other device for establishing communications over the WAN/Internet 454. The modem 457 is shown in FIG. 4 as communicatively linked between the interface 446 and the WAN/Internet 454. In a networked environment, program modules, application programs, or data, or portions thereof, can be stored in a server computer (not shown). Those skilled in the relevant art will readily recognize that the network connections shown in FIG. 4 are only some examples of establishing communication links between computers and/or robotic systems 460, and other links may be used, including wireless links.

The host computing system 410 may include one or more interfaces such as slot 458 to allow the addition of devices either internally or externally to the host computing system 410. For example, suitable interfaces may include ISA (i.e., Industry Standard Architecture), IDE, PCI (i.e., Personal Computer Interface) and/or AGP (i.e., Advance Graphics Processor) slot connectors for option cards, serial and/or parallel ports, USB ports (i.e., Universal Serial Bus), audio input/output (i.e., I/O) and MIDI/joystick connectors, and/or slots for memory, collectively referenced as 460.

The term “computer-readable medium” as used herein refers to any medium that participates in providing instructions to processor unit 412 for execution. Such a medium may take many forms, including but not limited to, non-volatile media, volatile media, and transmission media. Non-volatile media includes, for example, hard, optical or magnetic disks 25, 430, 432, respectively. Volatile media includes dynamic memory, such as system memory 414. Transmission media includes coaxial cables, copper wire and fiber optics, including the wires that comprise system bus 416. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor unit 412 for execution. For example, the instructions may initially be carried on a magnetic disk of a remote computer. The remote computer can load the instructions into its dynamic memory and send the instructions over a telephone line using a modem. A modem 457 local to computer system 410 can receive the data on the telephone line and use an infrared transmitter to convert the data to an infrared signal. An infrared detector coupled to the system bus 416 can receive the data carried in the infrared signal and place the data on system bus 416. The system bus 416 carries the data to system memory 414, from which processor unit 412 retrieves and executes the instructions. The instructions received by system memory 414 may optionally be stored on storage device either before or after execution by processor unit 412.

### CONCLUSION

As will be apparent to those skilled in the art, the various embodiments described above can be combined to provide further embodiments. Aspects of the present systems, articles and methods can be modified, if necessary, to employ systems, articles, methods and concepts of the various patents, applications and publications to provide yet further embodiments of the invention. For example, the various methods described above may omit some acts, include other acts, and/or execute acts in a different order than set out in the illustrated embodiments.

Various ones of the modules may be implemented in existing database software, whether client-side or server-side. Suitable client-side software packages include use in database API layering (e.g., ODBC, JDBC). Similarly, suitable server-side software packages include, but are not limited to, SQL-based database engines (e.g., MySQL, Microsoft SQL Server, PostgreSQL, Oracle, etc.).

The present systems, articles and methods also may be implemented as a computer program product that comprises a computer program mechanism embedded in a computer readable storage medium. For instance, the computer program product could contain program modules. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

While certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

We claim:

1. A computer-implemented method of performing preference filtering for a database query, the method comprising:
defining a number of conditions of a query;
determining an equivalence class for each of a number of tuples in a set of database tuples for which at least one preference is to be evaluated;
constructing a Better-Than Graph for the equivalence classes;
determining a Best Matches Only set of equivalence classes from the Better-Than Graph of the equivalence classes; and
returning the tuples resulting from the determining the Best Matches Only set of equivalence classes as the result of the preference filtering for the query.

2. The method of claim 1 wherein defining a number of conditions of a query includes receiving a set of user input indicative of at least one condition that a query result must exactly meet.

3. The method of claim 1 wherein defining a number of conditions of a query includes receiving a set of user input indicative of at least one condition that a query may or may not exactly meet.

4. The method of claim 1, further comprising:
determining a subset of database tuples that a query result must exactly meet before determining an equivalence class for each of a number of tuples in a set of database tuples, and wherein determining the equivalence class for each of the number of tuples in the set of database tuples includes determining a respective equivalence class only for the database tuples in the determined subset of database tuples.

5. The method of claim 1 wherein constructing a Better-Than Graph for the equivalence classes includes representing each equivalence class by a respective node in the Better-Than Graph, where a relative position of each node with respect to a connected node in a given direction represents a relative ranking of each equivalent class.

6. The method of claim 1 wherein determining a Best Matches Only set of equivalence classes from the Better-Than Graph of equivalence classes includes determining a skyline of the Better-Than Graph and thereby producing a set of skyline equivalence classes.

7. The method of claim 6 wherein returning any tuples resulting from the determining the Best Matches Only set of equivalence classes includes returning any tuples that are contained in the set of skyline equivalence classes.

8. The method of claim 6 wherein determining a skyline of the Better-Than Graph includes performing a depth-first search.

9. The method of claim 6 wherein determining a skyline of the Better-Than Graph includes performing a breadth-first search.

10. A computer-implemented method of performing preference filtering for a database query, the method comprising:
defining a number of conditions of a query, wherein at least one of the conditions is a requirement that must be exactly met by a query result and at least one of the conditions is a preference that may or may not be met by a query result;
defining a general query that ignores the preferences and uses only the requirements;
executing the general query to establish a subset of database tuples for which the preferences are to be evaluated;
determining an equivalence class for each tuple in the subset of database tuples for which the preferences are to be evaluated;
constructing a Better-Than Graph for the equivalence classes;
determining a Best Matches Only set of equivalence classes from the Better-Than Graph of equivalence classes; and
returning any tuples resulting from the determining the Best Matches Only set of equivalence classes as the result of the preference filtering for the query.

11. The method of claim 10 wherein constructing a Better-Than Graph for the equivalence classes includes representing each equivalence class by a respective node in the Better-Than Graph, where a relative position of each node with respect to a connected node in a given direction represents a relative ranking of each equivalent class.

12. The method of claim 10 wherein determining a Best Matches Only set of equivalence classes from the Better-Than Graph of equivalence classes includes determining a skyline of the Better-Than Graph and thereby producing a set of skyline equivalence classes.

13. The method of claim 12 wherein returning any tuples resulting from the determining the Best Matches Only set of equivalence classes includes returning any tuples that are contained in the set of skyline equivalence classes.

14. The method of claim 12 wherein determining a skyline of the Better-Than Graph includes performing a depth-first search.

15. The method of claim 12 wherein determining a skyline of the Better-Than Graph includes performing a breadth-first search.

16. A system to perform preference filtering for database queries, the system comprising:
a processor; and
a memory storing processor executable instructions that cause the processor to perform preference filtering for a database query by:
defining a number of conditions of a query;
determining an equivalence class for each of a number of tuples in a set of database tuples for which at least one preference is to be evaluated;
constructing a Better-Than Graph for the equivalence classes;
determining a Best Matches Only set of equivalence classes from the Better-Than Graph of the equivalence classes; and
returning the tuples that result from the determining a Best Matches Only set of equivalent classes.

17. The system of claim 16 wherein the processor determines a Best Matches Only set of equivalence classes from the Better-Than Graph of the equivalence classes by determining a skyline of the Better-Than Graph and thereby producing a set of skyline equivalence classes.

18. The system of claim 17 wherein returning the tuples that result from the determining a Best Matches Only set of equivalent classes including returning the tuples that are contained in the set of skyline equivalence classes as the result of the preference filtering for the query.

19. A system of performing preference filtering for database queries, the system comprising:
a processor; and
a memory storing processor executable instructions that cause the processor to perform preference filtering for a database query by:
defining a number of conditions of a query, wherein at least one of the conditions is a requirement that must be exactly met by a query result and at least one of the conditions is a preference that may or may not be met by the query result;
defining a general query that ignores the preferences and uses only the requirements;
executing the general query to establish a subset of database tuples for which the preferences are to be evaluated;
determining an equivalence class for each tuple in the subset of database tuples for which the preferences are to be evaluated;
constructing a Better-Than Graph for the equivalence classes;
determining a Best Matches Only set of equivalence classes from the Better-Than Graph of equivalence classes; and
returning any tuples that result from the determining the Best Matches Only set of equivalence classes as the result of the preference filtering for the query.

20. The system of claim 19 wherein the memory stores processor executable instructions that cause the processor to determine a Best Matches Only set of equivalence classes from the Better-Than Graph of the equivalence classes by determining a skyline of the Better-Than Graph and thereby producing a set of skyline equivalence classes.

21. The system of claim 20 wherein the memory stores processor executable instructions that cause the processor to returning the tuples that result from the determining a Best Matches Only set of equivalent classes by returning the tuples that are contained in the set of skyline equivalence classes as the result of the preference filtering for the query.

22. A system to perform preference filtering for database queries, the system comprising:
means for defining a number of conditions of a query, determining an equivalence class for each of a number of tuples in a set of database tuples for which at least one preference is to be evaluated, constructing a Better-Than Graph for the equivalence classes, determining a Best Matches Only set of equivalence classes from the Better-Than Graph of the equivalence classes by determining a skyline of the Better-Than Graph and thereby producing a set of skyline equivalence classes, and returning the tuples that are contained in the set of skyline equivalence classes as the result of the preference filtering for the query.

23. The system of claim 22 wherein the means comprises instructions stored on a computer readable medium.

24. A system of performing preference filtering for database queries, the system comprising:
means for defining a number of conditions of a query, wherein at least one of the conditions is a requirement that must be exactly met by a query result and at least one of the conditions is a preference that may or may not be met by the query result, defining a general query that ignores the preferences and uses only the requirements; executing the general query to establish a subset of database tuples for which the preferences are to be evaluated, determining an equivalence class for each tuple in the subset of database tuples for which the preferences are to be evaluated, constructing a Better-Than Graph for the equivalence classes, determining a Best Matches Only set of equivalence classes from the Better-Than Graph of equivalence classes by determining a skyline of the Better-Than Graph and thereby producing a set of skyline equivalence classes, and returning any tuples that are contained in the set of skyline equivalence classes as the result of the preference filtering for the query.

25. The system of claim 24 wherein the means comprises instructions stored on a computer readable medium.
